(19) United States
(12) Patent Application Publication
(10) Pub. No.: US 2024/0091729 A1
(43) Pub. Date: Mar. 21, 2024

(54) Fluidizing Device and Method for Treating Particulate Material

(71) Applicant: Glatt Gesellschaft mit beschränkter Haftung, Binzen (DE)

(72) Inventors: Dirk Zimmermann, Wehr (DE); Jochen Thies, Lörrach (DE); Heinz Gottschling, Weil am Rhein (DE)

(21) Appl. No.: 18/260,912

(22) PCT Filed: Dec. 16, 2021
(86) PCT No.: PCT/EP2021/086079

§ 371 Date: Jul. 10, 2023

(30) Foreign Application Priority Data
Jan. 11, 2021 (DE) 10 2021 200 161.0

(51) Int. Cl. B01J 8/18; B01J 8/00; B01J 8/44

(52) U.S. Cl. CPC B01J 8/1881; B01J 8/002; B01J 8/003; B01J 8/0035; B01J 8/1818; B01J 8/1872; B01J 8/44; B01J 2208/00769; B01J 2208/00884; B01J 2208/00938

(57) ABSTRACT

A fluidizing device for treating particulate material and to a method using the fluidizing device. The fluidizing device includes an inflow base that can be moved relative to the fluidizing unit. The inflow base in an emptying position is positioned at least partly below the top edge of a material outlet by moving the inflow base relative to the fluidizing unit, so that a fluid connection is formed between the material outlet arranged in the distributor chamber and the fluidizing chamber past the inflow base in order to discharge treated material from the fluidizing unit.

### CROSS-REFERENCE TO RELATED APPLICATIONS

This application is the United States national phase of International Application No. PCT/EP2021/086079 filed Dec. 16, 2021, and claims priority to German Patent Application No. 10 2021 200 161.0 filed Jan. 11, 2021, the disclosures of which are hereby incorporated by reference in their entireties.

### BACKGROUND

### Field

The invention relates to a fluidizing device for treating particulate material, having a fluidizing unit which has a longitudinal axis and a perforated inflow base that subdivides the fluidizing unit into a distributor chamber and a fluidizing chamber that is arranged above the distributor chamber, wherein the fluidizing chamber comprises a material inlet for the material to be treated and the distributor chamber comprises a material discharge having a material outlet for the treated material, which outlet has a material outlet area, a bottom edge and a top edge, wherein the inflow base in an operating position is arranged above the top edge of the material outlet and the distributor chamber comprises a fluid inlet and the fluidizing chamber comprises a fluid outlet for a process gas which flows from the fluid inlet through the perforated inflow base to the fluid outlet and fluidizes the material in the fluidizing chamber.

In addition, the invention relates to a method for treating particulate material in a fluidizing device, having a fluidizing unit which has a longitudinal axis and a perforated inflow base that subdivides the fluidizing unit into a distributor chamber and a fluidizing chamber that is arranged above the distributor chamber, wherein the fluidizing chamber comprises a material inlet for the material to be treated and the distributor chamber comprises a material discharge having a material outlet for the treated material, which outlet has a material outlet area, a bottom edge and a top edge, wherein the inflow base in an operating position is arranged above the top edge of the material outlet and the distributor chamber comprises a fluid inlet and the fluidizing chamber comprises a fluid outlet for a process gas which flows from the fluid inlet through the perforated inflow base to the fluid outlet and fluidizes the material in the fluidizing chamber, wherein, in an operating state, the fluidizing chamber is first filled with material to be treated via the material inlet and thereafter the material is treated by the process gas flowing through the fluidization chamber.

### DESCRIPTION OF RELATED ART

Fluidizing devices for treating particulate material and in particular fluidized bed apparatuses have been known for a long time.

EP 2 611 531 A1 discloses a fluid bed apparatus for processing particulate material, comprising a chamber enclosing a distributor chamber, a perforated inflow base arranged above the distributor chamber, an inlet and an outlet for the process gas and a discharge opening having a bottom edge and a top edge and defining a height and an opening area, wherein the inflow base is positioned above the bottom edge of the discharge opening such that the opening area of the discharge opening is divided into an opening area below the inflow base and an opening area above the inflow base.

The disadvantage of this is that a shut-off device, such as a flap, is required to close the fluid bed apparatus, the position of which device at the discharge opening requires a complex geometry adapted to the geometry of the fluid bed apparatus.

### SUMMARY

The object of the invention is therefore to further improve the emptying of a fluidizing device with respect to the emptying speed and to overcome the disadvantages of the prior art at the same time.

This object is achieved with a fluidizing device of the type mentioned at the outset by arranging the inflow base so that it can be moved relative to the fluidizing unit, wherein the inflow base in an emptying position is positioned at least partly below the top edge of the material outlet by moving the inflow base relative to the fluidizing unit, so that a fluid connection is formed between the material outlet arranged in the distributor chamber and the fluidizing chamber past the inflow base in order to discharge treated material from the fluidizing unit.

In the operating position, the inflow base is arranged above the top edge of the material outlet. If the inflow base is in the operating position, the fluidizing device is in the operating state. Therefore, in the operating position, the material can be treated without a material discharge via the material outlet in the fluidizing chamber.

In the emptying position, the inflow base is positioned at least partly below the top edge of the material outlet by moving the inflow base relative to the fluidizing unit. When in the emptying position, the fluidizing device is in the emptying state.

In the preferred fluidizing device, the inflow base separates in particular the fluidizing chamber and the distributor chamber from each other in the operating state. Therefore, because of the position of the inflow base in the operating state (operating position), specifically above a top edge of the material outlet, it is no longer absolutely necessary to seal the material outlet during treatment of the particulate material. The sealing device arranged at the material discharge can thus be omitted, which results in a significantly simpler technical design and therefore also involves a saving in manufacturing costs. The particulate material is fluidized in the fluidizing chamber such that the material behaves substantially like a liquid.

Advantageously, the relative movement between the inflow base and the fluidizing unit allows the particulate material to be emptied via the material discharge after it has been treated. The relative movement can be performed in such a way that the process gas assists the emptying of the treated material via the material discharge. In this case, the inflow base is positioned in the emptying position such that the material outlet area of the material outlet is divided into a process gas outlet area below the inflow base and a material outlet area above the inflow base.

According to an embodiment of the fluidizing device that is advantageous in this respect, the fluidizing unit has a pivot axis which extends transversely to the longitudinal axis of the fluidizing unit and on which the inflow base is pivotably arranged. It is expedient for the pivot axis to extend perpendicular to the central longitudinal axis of the fluidizing unit. This design allows a simple relative movement in the form of a pivoting movement about the pivot axis. As a result, the material outlet of the material discharge, which outlet is located in the distributor chamber, is opened in order to empty the material treated in the fluidizing chamber and, in addition, the material being emptied is conveyed due to the inclined position of the inflow base—as would be the case with a liquid. Furthermore, the inflow base is preferably pivoted about the pivot axis by an angle between 0° and 60°, expediently by an angle of 5° to 10°. On account of the pivoting movement, a substantially annular or crescent-shaped gap is formed between the inflow base and the distributor chamber and/or the fluidizing chamber; this gap must not become too large, as this otherwise brings the risk that, in the emptying state, treated material can enter the distributor chamber despite process gas flowing through the gap. In principle, the gap is sealed by the process gas.

In a further advantageous alternative embodiment of the fluidizing device, the inflow base is arranged such that it can be moved in the axial direction of the longitudinal axis. The inflow base is moved in the axial direction of the longitudinal axis in the form of a linear movement. It is expedient for the inflow base to be moved until the top side thereof is flush with or positioned below the bottom edge. Preferably, the inflow base is arranged such that it can be moved in the axial direction of the longitudinal axis. The alternative embodiment also allows the material outlet to be opened for improved emptying after the particulate material is treated.

Further advantageously, the fluidizing unit has a pivot axis which extends transversely to the longitudinal axis of the fluidizing unit, can be moved in the axial direction of the longitudinal axis and on which the inflow base is pivotably arranged. This embodiment of the fluidizing device combines the advantages of the two alternative embodiments of the preferred fluidizing device, specifically the pivoting movement and the linear movement. In addition, the gap that forms between the fluidizing unit and the inflow base is smaller.

According to an additional advantageous embodiment of the fluidizing device, the inflow base, in particular the top side of the inflow base, is positioned in the emptying position by moving the inflow base relative to the fluidizing unit so as to be flush with the bottom edge of the material outlet or at least partly below the bottom edge of the material outlet. Particularly preferably, the inflow base, in particular the top side of the inflow base, is positioned below the bottom edge of the material outlet in the emptying position by moving the inflow base relative to the fluidizing unit. This opens the material outlet area to the maximum extent such that the treated material can be emptied quickly and efficiently.

Further advantageously, the material discharge has a shut-off device. The material discharge can be closed or unblocked by the shut-off device. This makes it possible to control the time at which the material discharge is unblocked.

The object of the invention is additionally achieved with a method of the type mentioned at the outset, in which, after the operating state, the inflow base which can be moved relative to the fluidizing unit is moved into an emptying position in such a way that at least part of the inflow base is positioned below the top edge of the material outlet so that a fluid connection is formed between the material outlet arranged in the distributor chamber and the fluidizing chamber past the inflow base and the treated material is discharged from the fluidizing unit via the material outlet.

In the operating position, the inflow base is arranged above the top edge of the material outlet. If the inflow base is in the is operating position, the fluidizing device is in the operating state. Therefore, in the operating position, the material can be treated without a material discharge via the material outlet in the fluidizing chamber.

In the emptying position, the inflow base is positioned at least partly below the top edge of the material outlet by moving the inflow base relative to the fluidizing unit. When in the emptying position, the fluidizing device is in the emptying state.

In the preferred fluidizing device, the inflow base separates the fluidizing chamber and the distributor chamber from each other in the operating state. Therefore, because of the position of the inflow base in the operating state (operating state), specifically above a top edge of the material outlet, it is no longer absolutely necessary to seal the material outlet during treatment of the particulate material. The sealing device arranged at the material discharge can thus be omitted, which results in a significantly simpler technical design and therefore also involves a saving in manufacturing costs.

Advantageously, the relative movement between the inflow base and the fluidizing unit allows the particulate material to be emptied via the material discharge after it has been treated. The relative movement in the form of a pivoting and/or linear movement can be performed in such a way that the process gas assists the emptying of the treated material via the material discharge. In this case, the inflow base is positioned in the emptying position such that the material outlet area of the material outlet is divided into a process gas outlet area below the inflow base and a material outlet area above the inflow base.

According to a development of the method that is advantageous in this respect, the fluidizing unit has a pivot axis which extends transversely to the longitudinal axis of the fluidizing unit and on which the inflow base is pivotably arranged and about which the inflow base is pivoted, expediently by 5° to 10°, after the particulate material is treated. This design allows a simple relative movement in the form of a pivoting movement about the pivot axis. As a result, the material outlet of the material discharge, which outlet is arranged in the distributor chamber, is opened in order to empty the material treated in the fluidizing chamber and, in addition, the material being emptied is conveyed due to the inclined position of the inflow base.

Furthermore, the inflow base is preferably pivoted about the pivot axis by an angle between 0° and 60°, expediently by an angle of 5° to 10°. On account of the pivoting movement, a substantially crescent-shaped or annular gap is formed between the inflow base and the distributor chamber and/or the fluidizing chamber; this gap must not become too large, as this otherwise brings the risk that, in the emptying state, treated material can enter the distributor chamber despite process gas flowing through the gap. The process gas expediently seals the gap in the emptying state.

In a further advantageous embodiment of the method, the inflow base can be moved in the axial direction of the longitudinal axis and is moved in the axial direction of the longitudinal axis in the form of a linear movement, expediently until the inflow base is positioned below the bottom edge. Preferably, the inflow base is moved in the axial direction of the longitudinal axis. The alternative embodiment also allows the material outlet to be opened for improved emptying after the particulate material is treated.

Particularly preferably, the inflow base performs a pivoting movement and a linear movement when it is brought into the emptying position. In this respect, the inflow base is pivoted about the pivot axis by means of a pivoting movement and moved in the axial direction of the longitudinal axis in the form of a linear movement. The pivoting movement and the linear movement can be performed in any order, one after the other or at the same time. This brings about the advantages of both the pivoting and the linear movement.

According to an additional advantageous development of the method, the inflow base is moved relative to the fluidizing unit into the emptying position such that at least part of the inflow base is positioned below the bottom edge of the material outlet. Particularly preferably, the inflow base is moved relative to the fluidizing unit into the emptying position such that the inflow base is positioned below the bottom edge of the material outlet. Alternatively, the top edge of the inflow base is arranged so as to be flush with the bottom edge of the material outlet. In both cases, the material outlet area is opened to the maximum extent such that the treated material can be emptied quickly and efficiently.

Another advantageous aspect is that the material discharge has a shut-off device which unblocks the material discharge as soon as the inflow base is in the emptying position. The shut-off device expediently unblocks the material discharge as soon as at least part of the inflow base is positioned below the bottom edge of the material outlet. As a result, the material outlet area is opened to the maximum extent and the material treated in the fluidizing chamber of the fluidizing unit can be discharged from the fluidizing unit of the fluidizing device in an effective and time-saving manner.

### BRIEF DESCRIPTION OF THE DRAWINGS

The invention is explained in more detail below with reference to the accompanying drawings, in which:

FIG. 1 is a top view of a schematic representation of a first embodiment of a fluidizing device in the operating position with a sectional plane A-A;

FIG. 2 is a section along the sectional plane A-A shown in FIG. 1 through the schematic representation of the first embodiment of the fluidizing device in the operating position, in which an inflow base is arranged on a pivot axis in the horizontal position;

FIG. 3 is a section along the sectional plane A-A shown in FIG. 1 through the schematic representation of the first embodiment of the fluidizing device in the emptying position where the inflow base is arranged on the pivot axis in a position in which it is pivoted about the pivot axis by an angle α;

FIG. 4 is a top view of the schematic representation of the first embodiment of the fluidizing device in the emptying position;

FIG. 5 is a top view of a schematic representation of a second embodiment of a fluidizing device in the operating position with a sectional plane A-A;

FIG. 6 is a section along the sectional plane A-A shown in FIG. 5 through the schematic representation of the second embodiment of the fluidizing device in the operating position, in which an inflow base is arranged in a plane Z-Z in the horizontal position;

FIG. 7 is a section along the sectional plane A-A shown in FIG. 5 through the schematic representation of the second embodiment of the fluidizing device in the emptying position, in which the inflow base is arranged in a plane Z′-Z′ in the horizontal position;

FIG. 8 is an enlarged representation of the detail A shown in FIG. 7;

FIG. 9 is a top view of a schematic representation of a third embodiment of a fluidizing device in the operating position with a sectional plane A-A;

FIG. 10 is a section along the sectional plane A-A from FIG. 9 through the schematic representation of the third embodiment of the fluidizing device in the operating position, in which an inflow base is arranged in a plane Z-Z in the horizontal position; and

FIG. 11 is a section along the sectional plane A-A of FIG. 9 through the schematic representation of the third embodiment of the fluidizing device in the emptying position, where the inflow base is moved into a plane Z′-Z′ in the axial direction of the longitudinal axis X-X and pivoted about a pivot axis by an angle α.

### DETAILED DESCRIPTION

Unless otherwise stated, the following description refers to all the embodiments of a fluidizing device 1 for treating particulate material M that are illustrated in the drawings.

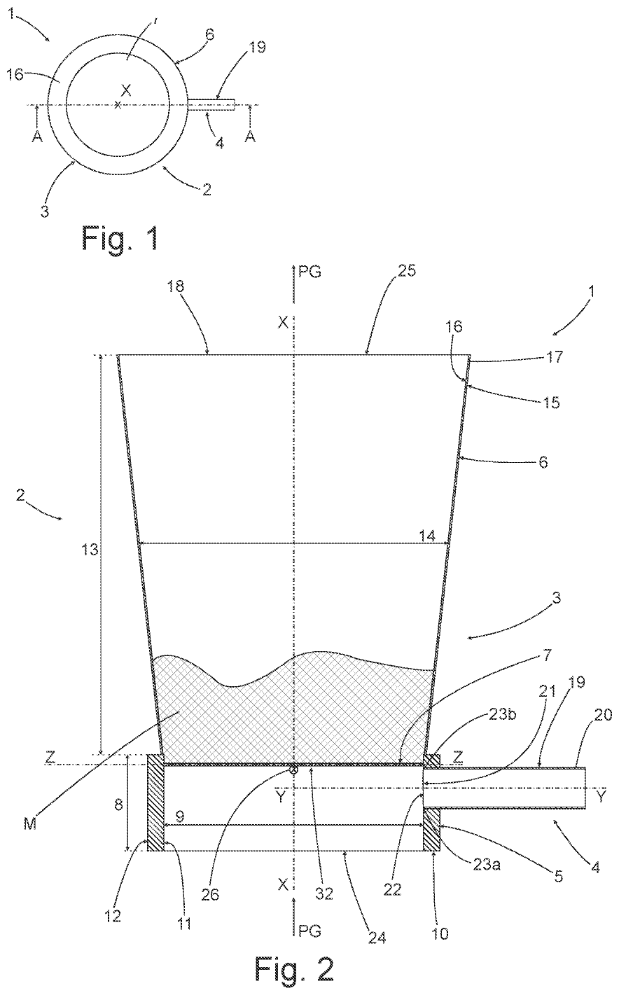

FIG. 1 shows a top view of a schematic representation of a first embodiment of the fluidizing device 1 designed as a fluidized bed apparatus 2 with a sectional plane A-A. The fluidizing device 1 comprises a fluidizing unit 3 which has a central longitudinal axis X-X and on which an emptying pipe 4 comprising a central axis Y-Y perpendicular to the longitudinal axis X-X is arranged. The central axis Y-Y and the longitudinal axis X-X span the sectional plane A-A. The fluidizing device 1 is in the operating state.

FIG. 2 shows a section along the sectional plane A-A shown in FIG. 1 through the schematic representation of the first embodiment of the fluidizing device 1, which is designed as a fluidized bed apparatus 2, in the operating position.

The fluidizing unit 3 comprises a perforated inflow base 7 that divides the fluidizing unit 3 into a distributor chamber 5 and a fluidizing chamber 6 that is arranged above the distributor chamber 5. In the operating position, the inflow base 7 lies in a plane Z-Z which is perpendicular to the sectional plane A-A, so that in the operating position the material M to be treated is located in the fluidizing chamber 6 above the inflow base 7. If the inflow base 7 is in the operating position, the fluidizing device 1 is in the operating state.

The fluidizing unit 3 of the fluidizing device 1, which is designed as a fluidized bed apparatus 2, is rotationally symmetrical about the central longitudinal axis X-X. Other geometric shapes, such as rectangular, in particular square, are implemented in other embodiments (not shown).

In the embodiment shown in FIG. 2, the distributor chamber 5 has a circular-cylindrical shape with a constant distributor-chamber inner diameter 9 over a distributor-chamber height 8. The distributor chamber 5 has a distributor chamber wall 10 radially spaced from the longitudinal axis X-X. The distributor chamber wall 10 has a distributor chamber wall 10 inner surface referred to as the distributor chamber inner wall 11 and a distributor chamber wall 10 outer surface referred to as the distributor chamber outer wall 12.

In the embodiment shown, the fluidizing chamber 6 is also circular-cylindrical, and the fluidizing chamber 6, in contrast to the distributor chamber 5, has a conical shape with a fluidizing-chamber inner diameter 14 which increases from the bottom to the top over a fluidizing-chamber height 13. The fluidizing chamber 6 has a fluidizing chamber wall 15 radially spaced from the longitudinal axis X-X. The fluidizing chamber wall 15 has a fluidizing chamber wall 15 inner surface referred to as the fluidizing chamber inner wall 16 and a fluidizing chamber wall 15 outer surface referred to as the fluidizing chamber outer wall 17.

In addition, the fluidizing chamber 6 comprises a material inlet 18 for the material M to be treated and the distributor chamber comprises a material discharge 19 for the treated material M′. The material discharge 19 is designed in particular as the emptying pipe 4 which has an emptying pipe wall 20 and which, in the embodiment shown in FIG. 2, is arranged perpendicular to the longitudinal axis X-X of the fluidizing unit 3 rotationally symmetrically about the central axis Y-Y in the distributor chamber wall 10. In this case, a material outlet 21 of the material discharge 19 is arranged in such a way that the material outlet 21 is flush with the distributor chamber inner wall 11. The material outlet 21 has a material outlet area 22 and has a bottom edge and a top edge 23a, 23b for discharging the material M′ treated in the fluidizing chamber 6.

Furthermore, the distributor chamber 5 has a fluid inlet 24 and the fluidizing chamber 6 has a fluid outlet 25. In the operating position shown in FIG. 2, the perforated inflow base 7 is arranged in a horizontal position in the plane Z-Z, a process gas PG entering the fluidizing unit 3 at the fluid inlet 24 and flowing from the fluid inlet 24 through the perforated inflow base 7 to the fluid outlet 25 where it exits the fluidizing unit 3. The perforated inflow base 7 expediently has passage openings (not shown) for the process gas PG which generate a pressure loss when the gas flows through them. The process gas PG fluidizes the material M to be treated in the fluidizing chamber 6 in the operating state, i.e. in the operating position of the inflow base 7.

The inflow base 7 is arranged in the fluidizing unit 3 such that it can be moved relative to the fluidizing unit 3. In the embodiment of the fluidizing device 1 shown in FIG. 2, the fluidizing unit 3 has a pivot axis 26 which extends transversely to the longitudinal axis X-X of the fluidizing unit 3 and on which the inflow base is 7 pivotably arranged. In the first embodiment of the fluidizing device 1 shown, the pivot axis 26 expediently extends perpendicular to the longitudinal axis X-X of the fluidizing unit 3 and perpendicular to the central axis Y-Y of the emptying pipe 4. In the operating state of the fluidizing device 1 shown in FIG. 2, the inflow base 7 is arranged above the top edge 23b. This ensures that no material M is discharged from the fluidizing unit 3 of the fluidizing device 1 while the particulate material M is being treated by the process gas PG in the fluidizing chamber 6.

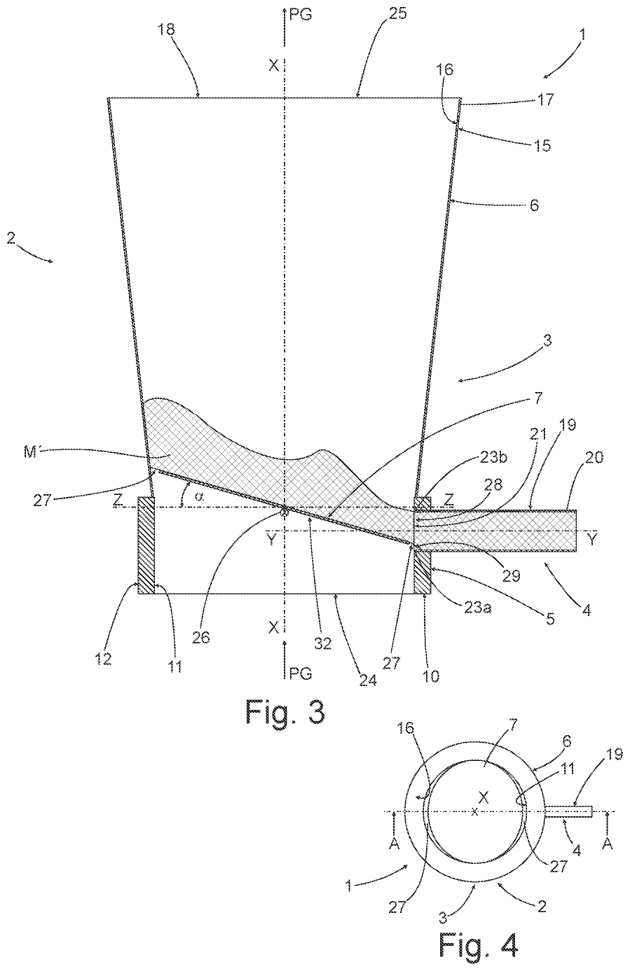

FIG. 3 shows the fluidizing device 1, which is designed as a fluidized bed apparatus 2, in the emptying state. After the particulate material M is treated in the fluidized bed apparatus 2, the treated material M′ is discharged from the fluidizing device 1 in the emptying state. For this purpose, the inflow base 7 is moved relative to the fluidizing unit 3 in the form of a pivoting movement so that said inflow base is positioned in the fluidizing unit 3 in the emptying position, pivoted about a pivot axis 26. In the emptying position, the inflow base 7 is pivoted by an angle α about the pivot axis 26 such that at least part of the inflow base 7 is positioned below the top edge 23b of the material outlet 21 so that a fluid connection is formed between the material outlet 21 arranged in the distributor chamber 5 and the fluidizing chamber 6 past the inflow base 7 in order to discharge the treated material M′ from the fluidizing unit 3 out of the fluidizing device 1 via the emptying pipe 4. The inflow base 7 is expediently pivoted by an angle of 5° to 10°. This causes the treated material M′ to flow towards the material outlet. The discharge of the treated material M′ is assisted by the process gas PG, which also flows, in the emptying state, from the fluid inlet 24 to the fluid outlet 25 through the fluidizing unit 3 of the fluidizing device 1. Preferably, due to the pivoting movement, part of the inflow base 7 is positioned below the bottom edge 23a. This opens the material outlet area 22 of the material outlet 21 as wide as possible, as a result of which an improved discharge of the treated material M′ is additionally conveyed.

In the emptying position, on account of the pivoting movement of the inflow base 7 pivoting about the pivot axis 26, a gap 27 is formed between the inflow base 7 and the fluidizing unit 3, in particular between the inflow base 7 and the distributor chamber inner wall 11 and/or the fluidizing chamber inner wall 16, which gap extends substantially around the entire circumference of the inflow base 7. The resulting gap width varies. Process gas PG flows through the gap 27 in the emptying state, so that treated material M′ cannot enter or fall into the distributor chamber 5 during discharge from the fluidizing chamber 6.

In the embodiment shown, the inflow base 7 is positioned in the emptying position such that the material outlet area 22 of the material outlet 21 is divided into a material outlet area 28 above the inflow base 7 and a process gas outlet area 29 below the inflow base 7.

FIG. 4 shows a top view of a schematic representation of the first embodiment of a fluidizing device 1 according to FIG. 1, wherein the fluidizing device 1 is in the emptying state. In this case, the inflow base 7 is arranged in a position in which it is pivoted about the pivot axis 26 by the angle θ6, as a result of which the gap 27, the width of which varies, is formed between the inflow base 7 and the fluidizing unit 3, in particular the distributor chamber inner wall 11 and/or the fluidizing chamber inner wall 16. Process gas PG flows through the gap 27 during the emptying process such that no treated material M′ can enter the distributor chamber 5.

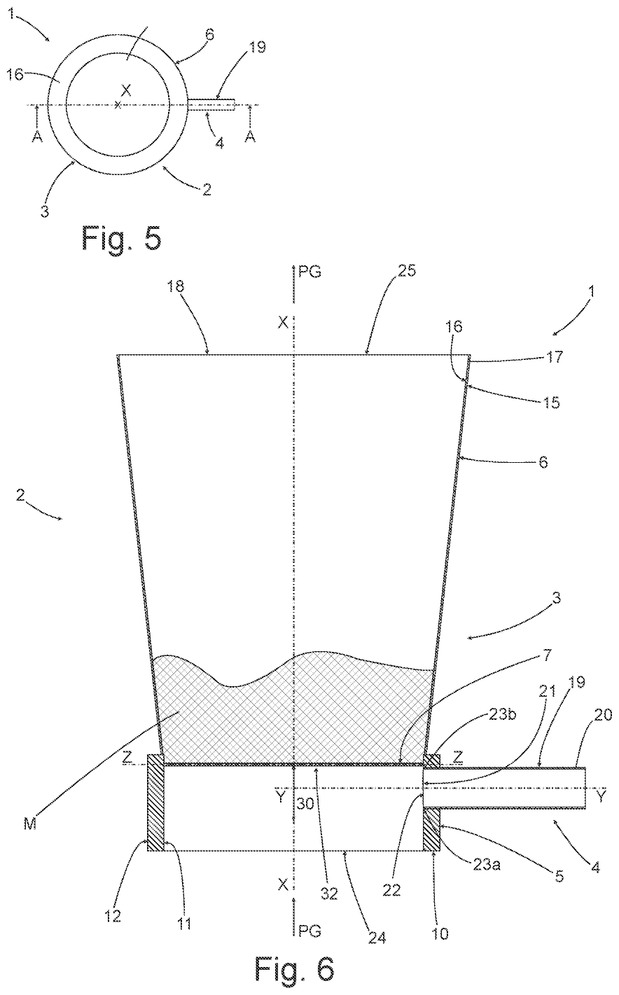

FIG. 5, corresponding to FIG. 1, shows a top view of a schematic representation of a second embodiment of the fluidizing device 1 designed as a fluidized bed apparatus 2 with a sectional plane A-A. The fluidizing device 1 comprises a fluidizing unit 3 which has a central longitudinal axis X-X and on which an emptying pipe 4 comprising a central axis Y-Y perpendicular to the longitudinal axis X-X is arranged. The central axis Y-Y and the longitudinal axis X-X span the sectional plane A-A. The fluidizing device 1 is in the operating state.

A section along the sectional plane A-A of FIG. 5 through the schematic representation of the second embodiment of the fluidizing device 1 in the operating state is shown in FIG. 6. In the operating position, the inflow base 7 lies in a plane Z-Z which is perpendicular to the sectional plane A-A, so that in the operating position the material M to be treated is located in the fluidizing chamber 6 above the inflow base 7.

Furthermore, the second embodiment of the fluidizing device 1 is substantially identical in terms of design to the first embodiment of the fluidizing device 1. The two embodiments differ only in the technical design of the relative movement executed between the fluidizing unit 3 and the inflow base 7. Instead of the pivoting movement—as in the first embodiment—the inflow base 7 in the second embodiment performs a linear movement in the axial direction 30 of the longitudinal axis X-X. The inflow base 7 can therefore be moved in the axial direction of the longitudinal axis X-X.

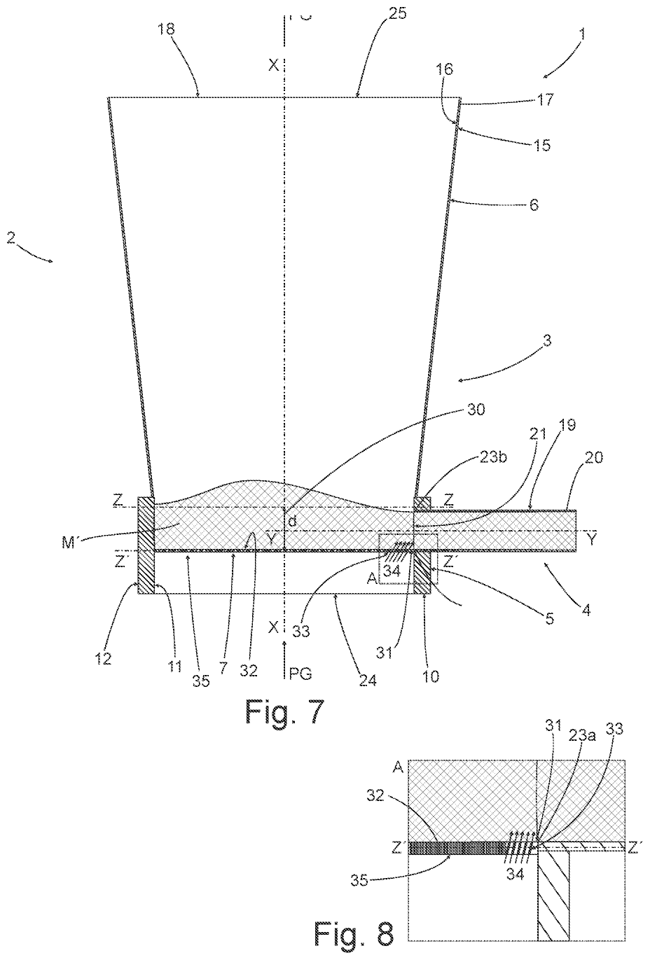

FIG. 7 shows a section along the sectional plane A-A from FIG. 5 through the schematic representation of the second embodiment of the fluidizing device 1 with an inflow base 7 in a horizontal position arranged in a plane Z′-Z′ in the emptying position. The plane Z′-Z′ is parallel to the plane Z-Z at a distance d. The inflow base 7 is moved downwards by the distance d in the axial direction 30 of the central longitudinal axis X-X, i.e. from the plane Z-Z into the plane Z′-Z′. It is expedient for a top edge 31 of the inflow base 7 or a top side 32 to be located at the same height as the bottom edge 23a of the material outlet 21. The top edge 31 and/or top side 32 are arranged in particular tangentially to the bottom edge 23a of the material outlet 21. The material outlet area 22 of the material outlet 21 is therefore completely open such that the discharge of treated material M′ can be improved.

It is expedient for discharge openings 33 to be located in the perforated inflow base 7 in the region of the material outlet 21 and to be aligned towards the material outlet 21 as per the arrows 34 shown. This additionally assists the discharge of the treated material M′ by the process gas PG in the emptying state.

FIG. 8 is an enlarged representation of the detail A shown in FIG. 7, which represents the region of the material outlet 21. The perforated inflow base 7 has passage openings 35 through which the process gas PG flows in order to fluidize the particulate material M to be treated in the fluidizing chamber 6. The passage openings 35 can be located as desired and are designed according to the specific requirements with respect to number and passage opening diameter. In the region of the material outlet 21, discharge openings 33 are located in the perforated inflow base 7. The process gas PG flows in the direction of the arrows 34 through the discharge openings 33 and thus assists quick and efficient discharge of the treated material M′ in the emptying position. In addition, the top edge 31 and/or the top side 32 of the inflow base 7 is lowered until it is flush with the level of the bottom edge 23a of the material outlet 21, as a result of which the discharge of treated material M′ is additionally facilitated due to the material outlet area 22 being as large as possible.

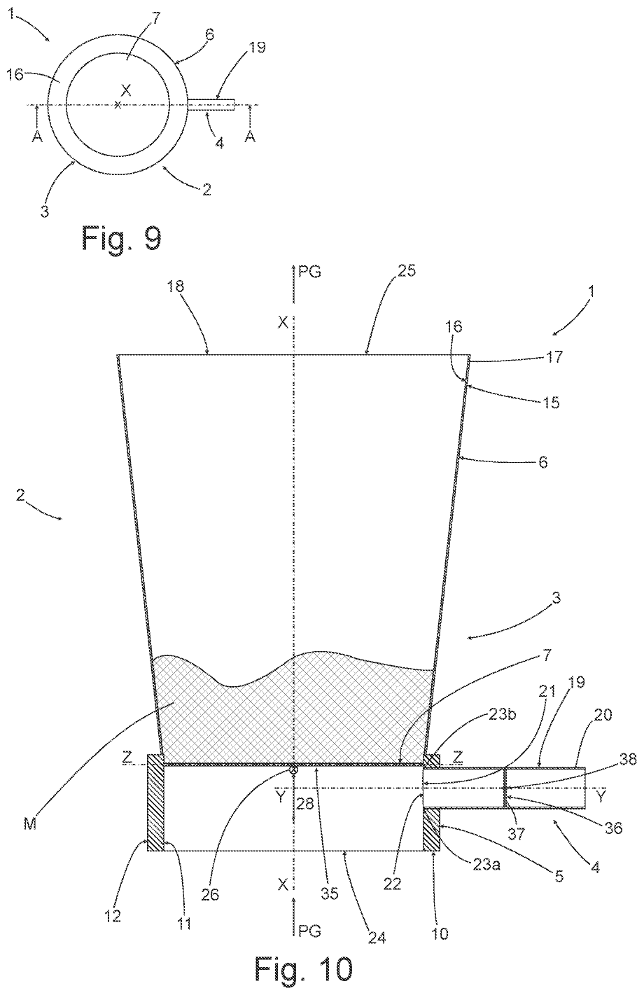

FIG. 9 shows a top view of a schematic representation of a third embodiment of the fluidizing device 1 designed as a fluidized bed apparatus 2 with a sectional plane A-A. The fluidizing device 1 comprises a fluidizing unit 3 which has a central longitudinal axis X-X and on which an emptying pipe 4 comprising a central axis Y-Y perpendicular to the longitudinal axis X-X is arranged, the central axis Y-Y and the longitudinal axis X-X spanning the sectional plane A-A. The fluidizing device 1 is in the operating state.

FIG. 10 shows a section along the sectional plane A-A from FIG. 9 through the schematic representation of the third embodiment of the fluidizing device 1 in the operating position, in which an inflow base 7 is arranged in a plane Z-Z in the horizontal position.

The third embodiment of the fluidizing device 1 is essentially a combination of the first two embodiments. In the third embodiment, too, the inflow base 7 can be moved relative to the fluidizing unit 3. In contrast to the first and second embodiments, the inflow base 7 of the third embodiment is suitable for performing both a pivoting movement about the pivot axis 26 and a linear movement in the axial direction 30 of the longitudinal axis X-X. In the operating state shown, the particulate material M is treated in the fluidizing chamber 6.

The pivoting movement and the linear movement of the inflow base when being brought into the emptying position can be performed in any order, one after the other or at the same time. This brings about the advantages of both the pivoting and the linear movement.

Furthermore, the material discharge 19 has a shut-off device 36. The shut-off device 36 is expediently designed as a flap 37, valve, rotary valve or the like. The shut-off device 36, when designed as a flap 37, seals or unblocks the material discharge 19. In the operating state shown in FIG. 10, in which the inflow base 7 is above the top edge of the material outlet 21, the shut-off device 36 is sealing the material discharge. Consequently, neither process gas PG nor material M to be treated can flow out of or be discharged from the fluidizing unit 3 of the fluidizing device 1. In the embodiment shown, the flap 37 can be pivoted about a pivot axis 38 which is located normal to the central axis Y-Y.

In the emptying state, the particulate material M′ treated in the fluidizing chamber 6 is discharged from the fluidizing unit 3 of the fluidizing device 1 via the material discharge 19, which is designed as an emptying pipe 4. In this case, the shut-off device 36 is pivoted about the pivot axis 38 and unblocks the material discharge 19 in the emptying state, in which the inflow base is located at least partly below the top edge of the material outlet 21.

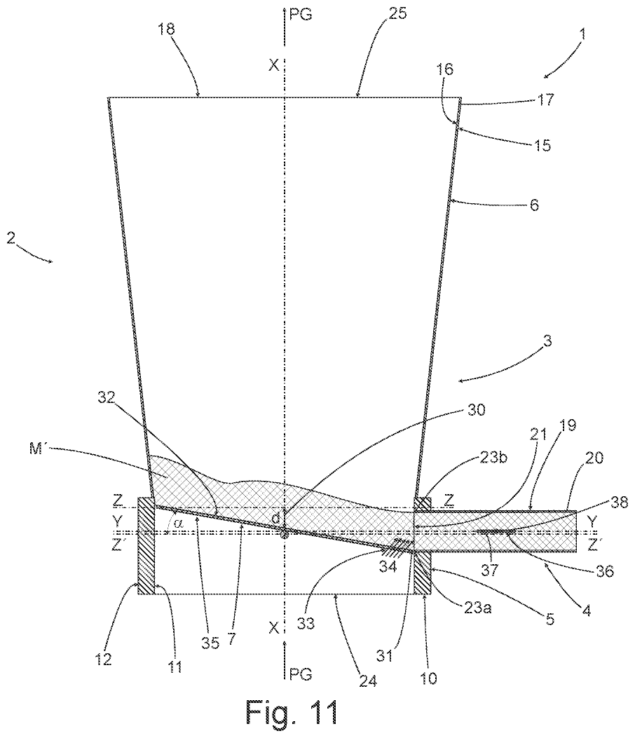

In this regard, FIG. 11 shows a section along the sectional plane A-A of FIG. 9 through the schematic representation of the third embodiment of the fluidizing device 1.

The inflow base 7 is pivoted about the pivot axis 26 by an angle α and, in addition, the pivot axis 26 is moved in the axial direction 30 of the longitudinal axis X-X from a plane Z-Z into a plane Z′-Z′ aligned parallel to the plane Z-Z. By lowering the pivot axis 26 of the inflow base 7 from a plane Z-Z into a parallel plane Z′-Z′ moved by the distance d and by simultaneously pivoting the inflow base 7 about the pivot axis 26, an improved discharge of the treated material M′ from the fluidizing chamber 6 is brought about. In the embodiment shown, the plane Z′-Z′ is located below the central axis Y-Y. This makes it possible to keep the angle α by which the inflow base 7 and the pivot axis 26 are pivoted small so as to minimise the gap 27 formed between the inflow base 7 and the fluidizing unit 3. This results in a further improved discharge.

In the emptying position the top side 32 of the inflow base 7 is positioned at least partly below the bottom edge 23a of the material outlet 21. The material discharge 19, which contains the shut-off device 36, is unblocked as a result of the shut-off device 36 being pivoted about the pivot axis 38 so that the treated material M′ can be discharged.

1. A fluidizing device for treating particulate material, comprising:
a fluidizing unit which has a longitudinal axis and a perforated inflow base that subdivides the fluidizing unit into a distributor chamber and a fluidizing chamber that is arranged above the distributor chamber,
wherein the fluidizing chamber comprises a material inlet for the material to be treated and the distributor chamber comprises a material discharge having a material outlet for the treated material, which outlet has a material outlet area, a bottom edge and a top edge,
wherein the inflow base in an operating position is arranged above the top edge of the material outlet and the distributor chamber comprises a fluid inlet and the fluidizing chamber comprises a fluid outlet for a process gas which flows from the fluid inlet through the perforated inflow base to the fluid outlet and fluidizes the material in the fluidizing chamber,
wherein the inflow base can be moved relative to the fluidizing unit, and
wherein the inflow base in an emptying position is positioned at least partly below the top edge of the material outlet by moving the inflow base relative to the fluidizing unit, so that a fluid connection is formed between the material outlet arranged in the distributor chamber and the fluidizing chamber past the inflow base in order to discharge treated material from the fluidizing unit.

2. The fluidizing device according to claim 1, wherein the fluidizing unit has a pivot axis which extends transversely to the longitudinal axis of the fluidizing unit and on which the inflow base is pivotably arranged.

3. The fluidizing device according to claim 2, wherein the pivot axis extends perpendicular to the longitudinal axis of the fluidizing unit.

4. The fluidizing device according to claim 1, wherein the inflow base can be moved in the axial direction of the longitudinal axis.

5. The fluidizing device according to claim 1, wherein the fluidizing unit has a pivot axis which extends transversely to the longitudinal axis of the fluidizing unit, can be moved in the axial direction of the longitudinal axis and on which the inflow base is pivotably arranged.

6. The fluidizing device according to claim 1, wherein the inflow base is positioned in the emptying position by moving the inflow base relative to the fluidizing unit so as to be flush with the bottom edge of the material outlet or at least partly below the bottom edge of the material outlet.

7. The fluidizing device according to claim 6, wherein the inflow base, is positioned below the bottom edge of the material outlet in the emptying position by moving the inflow base relative to the fluidizing unit.

8. The fluidizing device according to claim 1, wherein the material discharge contains a shut-off device.

9. A method for treating particulate material in a fluidizing device, having a fluidizing unit which has a longitudinal axis and a perforated inflow base that subdivides the fluidizing unit into a distributor chamber and a fluidizing chamber that is arranged above the distributor chamber, wherein the fluidizing chamber comprises a material inlet for the material to be treated and the distributor chamber comprises a material discharge having a material outlet for the treated material, which outlet has a material outlet area, a bottom edge and a top edge, wherein the inflow base in an operating position is arranged above the top edge of the material outlet and the distributor chamber comprises a fluid inlet and the fluidizing chamber comprises a fluid outlet for a process gas which flows from the fluid inlet through the perforated inflow base to the fluid outlet and fluidizes the material in the fluidizing chamber, wherein, in an operating state, the fluidizing chamber is first filled with material to be treated via the material inlet and thereafter the material is treated by the process gas flowing through the fluidization chamber wherein, after the operating state, the inflow base which can be moved relative to the fluidizing unit is moved into an emptying position in such a way that at least part of the inflow base is positioned below the top edge of the material outlet so that a fluid connection is formed between the material outlet arranged in the distributor chamber and the fluidizing chamber past the inflow base and the treated material is discharged from the fluidizing unit via the material outlet.

10. The method according to claim 9, wherein the fluidizing unit has a pivot axis which extends transversely to the longitudinal axis of the fluidizing unit and on which the inflow base is pivotably arranged and about which the inflow base is pivoted, expediently by 5° to 10°, after the particulate material is treated.

11. The method according to claim 9, wherein the inflow base can be moved in the axial direction of the longitudinal axis and is moved in the axial direction of the longitudinal axis in the form of a linear movement, expediently until the inflow base is positioned below the bottom edge.

12. The method according to claim 10, wherein the inflow base performs a pivoting movement and a linear movement when being brought into the emptying position.

13. The method according to claim 9, wherein the inflow base is moved relative to the fluidizing unit into the emptying position such that at least part of the inflow base is positioned below the bottom edge of the material outlet.

14. The method according to claim 13, wherein the inflow base is moved relative to the fluidizing unit into the emptying position such that the inflow base is positioned below the bottom edge of the material outlet.

15. The method according to claim 9, wherein the material discharge has a shut-off device which unblocks the material discharge as soon as the inflow base is in the emptying position.

16. The method according to claim 15, wherein the shut-off device unblocks the material discharge as soon as at least part of the inflow base is positioned below the bottom edge of the material outlet.

17. The fluidizing device according to claim 6, wherein the top side of the inflow base is positioned in the emptying position by moving the inflow base relative to the fluidizing unit so as to be flush with the bottom edge of the material outlet or at least partly below the bottom edge of the material outlet.

18. The fluidizing device according to claim 7, wherein the top side of the inflow base is positioned below the bottom edge of the material outlet in the emptying position by moving the inflow base relative to the fluidizing unit.
